(19) United States
(12) Patent Application Publication
(10) Pub. No.: US 2008/0260957 A1
(43) Pub. Date: Oct. 23, 2008

(54) Method for adhering a thermally-conductive silicone composition, a primer for adhering a thermally-conductive silicone composition and a method for manufacturing a bonded complex of a thermally-conductive silicone composition

(76) Inventors: Kunihiro Yamada, Annaka-shi (JP); Akihiro Endo, Annaka-shi (JP); Kei Miyoshi, Annaka-shi (JP)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 11/977,577

(22) Filed: Oct. 25, 2007

(30) Foreign Application Priority Data
Oct. 27, 2006 (JP) 2006-291907

(51) Int. Cl. B05D 3/00; C09D 4/00

(52) U.S. Cl. 427/387; 427/372.2; 106/287.18

(57) ABSTRACT

A method for adhering a thermally-conductive silicone composition to a coated surface in which a primer containing a platinum type compound and a solvent but not containing an alkoxy silane is applied and dried on the surface of a metal or an alloy containing at least one metal selected from a group of gold, silver and platinum group, and the thermally-conductive silicone composition is subsequently adhered to the coated surface.

### CROSS-REFERENCE TO RELATED APPLICATION

This application claims the benefit of Japanese Patent Application No. 2006-291907 filed on Oct. 27, 2006, the entire disclosure of which is herein incorporated by reference.

### FIELD OF THE INVENTION

This invention relates to a method for adhering a thermally-conductive silicone composition on the surface of precious metal such as gold, a primer used for this purpose and a method for manufacturing a bonding complex of the thermally-conductive silicone composition.

### DESCRIPTION OF THE RELATED ART

Previously, a method in which a material imparting adhesive properties to a silicone resin is added or in which a silicone resin is applied and, cured after applying a primer containing silicone or a silane coupling agent first to a substrate surface was most commonly used as a method to bond a silicone resin to a substrate. As an example of a technique using a primer, a technique in which a primer composition containing an alkoxysilane and a platinum type compound is applied to a substrate surface, allowed to dry and a silicone rubber is adhered to this surface has been disclosed. (See, for example, Japanese Examined Patent Application Publication H03-12114, Japanese Unexamined Patent Application Publication H09-208923)

However, the problem with the techniques described above is the difficulty encountered in adhering a silicone composition to the surfaces of precious metals such as gold. A component contained in a silicone composition or reactive groups in a primer ordinarily react with substituents on a substrate surface to generate adhesive force through chemical bond. However, substituents are extremely rare on the surface of precious metals such as gold, and the action described is thought not to occur easily.

### SUMMARY OF THE INVENTION

Therefore, the object of the invention is to provide a method that can adhere a thermally-conductive silicone composition to the surface of precious metals such as gold, a primer that can be used to adhere a thermally-conductive silicone composition and a method for manufacturing a bonded complex of a thermally-conductive silicone composition.

As a result of an intense investigation conducted by the inventors, the inventors discovered that the adhesive properties of a thermally-conductive silicone composition to the surface of precious metals such as gold declined when an alkoxysilane was present in a primer. That is, in order to achieve the object described above, the present invention describes a method for adhering a thermally-conductive silicone composition to a coated surface in which a primer containing a platinum type compound and a solvent but not containing an alkoxy silane is applied and dried on the surface of a metal or an alloy containing at least one metal selected from a group of gold, silver and platinum group, and the thermally-conductive silicone composition is subsequently adhered to the coated surface.

Preferably, the thermally-conductive silicone composition contains

(A) an organo polysiloxane containing at least two alkenyl groups in a molecule and having a viscosity at 25° C. of from 10 mm²/s to 100,000 mm²/s and
(B) an organohydrogen polysiloxane shown by the General Formula (1) below.

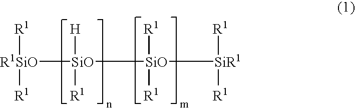

[in the formula R¹ represents an alkyl group with one to six carbon atoms and n and m indicate positive numbers that satisfy 0.01≦n/(n+m)≦0.3.]

In accordance with second aspect of the present invention, three is provided a primer for adhering a thermally-conductive silicone composition containing at least one material selected from a group of platinum free particles, platinum supported particles, chloroplatinic acid, platinum complexes and platinum coordinate compounds yet not containing an alkoxy silane that is used to adhere the thermally-conductive silicone composition on the surface of a metal or an alloy containing at least one metal selected from a group of gold, silver and platinum group.

In accordance with third aspect of the present invention, three is provided a method for manufacturing a bonded complex of a thermally-conductive silicone composition in which a primer containing a platinum type compound and a solvent but not containing an alkoxy silane is applied and dried on the surface of a metal or an alloy containing at least one metal selected from a group that includes gold, silver and platinum group, and the thermally-conductive silicone composition is subsequently adhered to the coated surface.

In accordance with the present invention, three is provided a method for manufacturing a bonded complex of a thermally-conductive silicone composition in which a primer containing a platinum type compound and a solvent but not containing an alkoxy silane is applied and dried on the surface of a metal or an alloy containing at least one metal selected from a group that includes gold, silver and platinum group, and the thermally-conductive silicone composition is subsequently adhered to the coated surface.

According to the present invention, thermally-conductive silicone compositions can be adhered to the surface of precious metals such as gold and the like.

### BRIEF DESCRIPTION OF THE DRAWING

FIG. 1 shows a schematic diagram of a test piece preparation and adhesive force measuring methods.

### DESCRIPTION OF THE PREFERRED EMBODIMENTS

The embodiments of the present invention are explained below.

<Adherend>

In the present invention, the target (adherend) to which thermally-conductive silicone compositions adhere is the surface of a metal or an alloy containing at least one metal selected from a group of gold, silver and platinum group. The platinum group includes six elements: ruthenium, rhodium, palladium, osmium, iridium and platinum. The eight elements above are also referred to as precious metals. In addition, the alloy is an alloy comprising at least one metal selected from the eight elements above. Substituents are extremely rare on precious metal surfaces, and chemical bonds with the reactive groups in a primer form with difficulty, generally lowering the adhesive force to thermally-conductive silicone compositions. Now, substrate surfaces on which a layer of the metals or alloys described above have been formed using plating, deposition and the like are also considered adherends.

<Primer>

The primer used in the present invention contains a platinum type compound and a solvent but does not contain an alkoxysilane.

[Platinum Type Compound]

As the platinum type compound, at least one material selected from a group of platinum free particles, platinum supported particles, chloroplatinic acid, platinum complexes and platinum coordinate compounds may be cited. As the platinum supported particles, platinum particles supported on silica, aluminum, carbon black and the like may be used. As the platinum complexes, platinum-olefin complexes, platinum-alcohol complexes, platinum-vinyl siloxane complexes, platinum-phosphine complexes, platinum-phosphite complexes and the like may be listed as examples.

The proportion of a platinum type compound in a primer is preferably from 0.01% by weight to 2.0% by weight calculated in terms of platinum contained in the platinum type compound in the primer solvent. When the platinum type compound concentration is less than 0.01% by weight, the adhesive force may not improve. When the concentration exceeds 2.0% by weight, the effect reaches its maximum and tends to become uneconomical.

[Solvent]

In order to make the primer easy to use, a platinum type compound is diluted in a solvent. As the solvent, those with relatively good volatility are preferred for shortening the drying (air drying) time for the primer. For example, organic solvents such as toluene, isopropyl alcohol and the like may be listed, but the solvent is not limited to these examples.

[Alkoxysilane]

The primer used in the present invention is characterized by not containing an alkoxysilane. The results of the intense study conducted by the inventors indicated that the adhesive properties of a thermally-conductive silicone composition on a precious metal surface declined when an alkoxysilane was present in the primer.

An alkoxysilane is a compound that contains alkoxysilyl groups, particularly a compound that contains trialkoxysilyl groups. As the compound containing trialkoxysilyl groups, the alkenyl trialkoxysilanes (for example, allyl trimethoxysilane) described in Japanese Unexamined Patent Application Publication H09-208923 may be cited. In addition, as the compound containing trialkoxysilyl groups, the silane compounds described in Japanese Examined Patent Application Publication H03-12114 [those represented by the general formula (2) of the patent claims of the same publication, for example, gamma-methacryloxy propyl trimethoxysilane] may be cited.

<Thermally-Conductive Silicone Composition>

The thermally-conductive silicone compositions to which the present invention can be applied are heat curing types. The use of a composition containing (A) an organo polysiloxane containing at least two alkenyl groups in a molecule and having a viscosity at 25° C. of from 10 mm²/s to 100,000 mm²/s and (B) an organohydrogen polysiloxane indicated by the General Formula (1) below as the thermally-conductive silicone composition is preferred since it further improves adhesive properties to a precious metal surface.

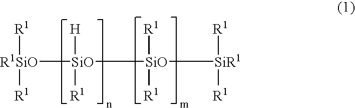

[in the formula R¹ represents an alkyl group with one to six carbon atoms and n and m indicate positive numbers that satisfy 0.01≦n/(n+m)≦0.3.]

By adding the components (A) and (B) and by adding a catalyst selected from platinum and platinum compounds as necessary, the components (A) and (B) undergo an addition reaction when heat cured. The heat cured material of the components (A) and (B) contains a mixture of segments containing alkenyl groups in siloxane chains or siloxane terminals and segments containing Si—H groups. The thermally-conductive silicone composition described above may also contain a component containing epoxy groups or alkoxy groups and the like as an adhesive component when necessary.

Now, both the components (A) and (B) described above are identical to the components (A) and (B) described in Japanese Patent No. 3,580,366. Furthermore, a composition to which the components (C) through (F) described in the same patent are added may be used as the thermally-conductive silicone composition. The proportions with which individual components are mixed may be identical to the one described in the same patent. In addition, the component (E) described in the same patent may be used as the catalyst selected from platinum and platinum compounds described above.

Furthermore, a controlling agent selected from acetylene compounds, various nitrogen compounds, organic phosphorus compounds, oxime compounds and organic chloro compounds may also be added for the purpose of controlling the reaction of the thermally-conductive silicone composition described above. Furthermore, the thermally-conductive silicone composition described above may also contain a filler as a thickener. As the filler, any one that thickens silicone may be used, but metal powder, ceramic powder, metal oxide powder, carbon and the like, for example, may be cited.

<Primer Application>

As a method used to apply the primer described above to an adherend, dipping, gauze application, spray application and the like may be cited, but gauze application and spray application are simple and also economical. One application is acceptable as the number of applications, but the application may be repeated at least twice as needed. Air drying for about an hour at room temperature is sufficient for drying after the primer application, but a dryer and the like may also be used to accelerate the evaporation of the solvent in the primer.

By placing the thermally-conductive silicone composition described above on a surface to be coated after applying and drying the primer and heat curing it, a thermally-conductive silicone composition can be bonded to an adherend. The heating method for the thermally-conductive silicone composition is not particularly restricted, but the use of an oven is preferred. The heating temperature is from about 100° C. to 180° C. and a heating time of several minutes to several hours is preferred but not limited to these ranges.

The method of the present invention for manufacturing a bonded complex of a thermally-conductive silicone composition involves applying the primer on the adherend described above and subsequently adhering the thermally-conductive silicone composition described above to produce a composite material comprising the adherend and the thermally-conductive silicone composition.

### EXAMPLES

The present invention is described below by citing examples, but the present invention is not limited to these examples. In addition, the terms “parts” and “%” in the examples indicate parts by weight and % by weight unless clearly indicated otherwise.

<Adherend Preparation>

Adherend 1: Gold was deposited on one side of a 10 mm square silicon wafer to obtain an adherend with a gold surface.

Adherend 2: Gold was not deposited on one side of a 10 mm square silicon wafer to obtain an adherend without a gold surface.

<Primer Preparation>

Primer A: A platinum-vinylsiloxane complex was dissolved in toluene (solvent) to prepare a 0.5% solution.

Primer B: Allyl trimethoxysilane was dissolved in toluene (solvent) to prepare a 10% solution.

Primer C: The platinum-vinylsiloxane complex and allyl trimethoxysilane were dissolved in toluene (solvent) to prepare a 0.5% and 10% solution, respectively.

<Thermally-Conductive Silicone Composition Preparation>

As component (A), 100 g of dimethyl polysiloxane having both ends terminated with dimethylvinyl silyl groups and having a viscosity at 25° C. of 600 mm²/s was added. Furthermore, 800 g of aluminum powder with an average particle size of 4.9 μm, 200 g of zinc oxide powder with an average particle size of 1.0 μm and 6 g of C₁₀H₂₁Si(OCH₃)₃, a coupling agent, were added, and the mixture was heated and agitated for an hour at 70° C. using a five liter planetary mixer. After cooling, 0.45 g of a 50% toluene solution of 1-ethynyl-1-cyclohexanol was added to the mixture. Furthermore, 0.2 g of a 0.5% toluene solution of platinum-vinyl siloxane complex was added with agitation. Next, 11.7 g of the Si—H group-containing organo polysiloxane represented by the Formula (2) was added as component (B) with agitation to obtain a thermally-conductive silicone composition.

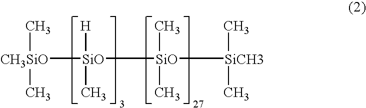

<Test Piece Preparation and Adhesive Force Measurement>

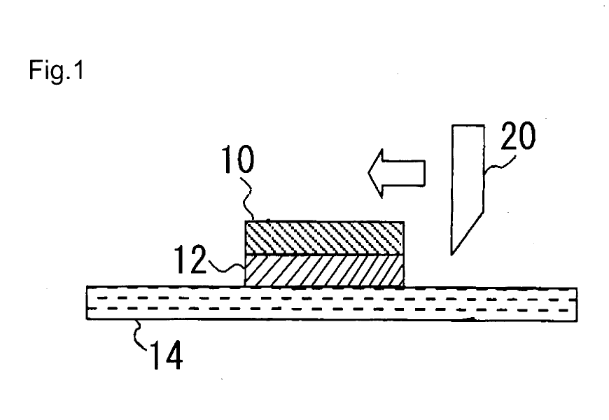

As shown in FIG. 1, a 25 mm×100 mm piece of a nickel sheet (14) (manufactured by Test Piece Corp.) having a nickel coating on an iron surface was prepared, and a thermally-conductive silicone composition (12) was sandwiched between the nickel sheet (14) and the adherend (10). The laminated material (10, 12, 14) was placed in a 125° C. oven for ninety minutes to heat cure the thermally-conductive silicone composition (12) to prepare a test piece. Furthermore, the test piece was aged for two hundred hours at 125° C. before its fracture load was measured by adding a load using a probe (20) from the side of the adherend (10), and the measured value was reported as the adhesive force. The adhesive force measurement was conducted using Bonding Tester PTR-1000 manufactured by Rhesca Company Ltd, and an average value calculated using three measurements was used.

### Example 1

A coating of Primer A was applied by wiping the gold deposited surface of Adherend 1 once using a gauze impregnated with Primer A, and the coating was air dried for an hour at room temperature. A test piece of this coated surface was prepared according to the method described above, and the adhesive force was measured. The adhesive force was 55N.

### Comparative Example 1

A test piece was prepared in the manner described in Example 1 with the exception that Adherend 2 was used in place of Adherend 1, and the adhesive force was measured. The adhesive force was 31N.

### Comparative Example 2

A test piece was prepared in the manner described in Example 1 with the exception that Adherend 2 was used in place of Adherend 1 and Primer A was not applied on Adherend 2. The adhesive force was measured, and the adhesive force was 28N.

### Comparative Example 3

A test piece was prepared in the manner described in Example 1 with the exception that Primer A was not applied on a gold deposited surface of Adherend 1 and instead a gauze impregnated in Primer A was used to wipe once the surface of the nickel sheet described above to apply a coating. The coated surface was air dried for an hour at room temperature and the adhesive force was measured, the adhesive force was 24N.

### Comparative Example 4

A test piece was prepared in the manner described in Example 1 with the exception that Primer B was used in place of Primer A, and the adhesive force was measured. The adhesive force was 28N.

### Comparative Example 5

A test piece was prepared in the manner described in Example 1 with the exception that Primer C was used in place of Primer A, and the adhesive force was measured. The adhesive force was 44N.

As clarified above, the adhesive force of a thermally-conductive silicone composition to a gold surface improved when a primer containing a platinum-vinyl siloxane complex and a solvent but not containing alkoxy silane was used as in the case of Example 1.

In contrast, the adhesive force of a thermally-conductive silicone composition did not improve when a primer containing a platinum-vinyl siloxane complex and not containing alkoxy silane was applied to the silicon surface as in the case of Comparative Example 1.

The adhesive force of a thermally-conductive silicone composition did not improve when a primer was not applied to the silicon surface as in the case of Comparative Example 2.

The adhesive force of a thermally-conductive silicone composition also did not improve when a primer was not applied to the gold surface as in the case of Comparative Example 3.

The adhesive force of a thermally-conductive silicone composition did not improve when a primer not containing a platinum-vinyl siloxane complex but containing alkoxy silane (allyl trimethoxysilane) was applied to the gold surface as in the case of Comparative Example 4.

The adhesive force of a thermally-conductive silicone composition was inferior to that of Example 1 when a primer containing both a platinum-vinyl siloxane complex and alkoxy silane (allyl trimethoxysilane) was applied to the gold surface as in the case of Comparative Example 5.

What is claimed is:

1. A method for adhering a thermally-conductive silicone composition to a coated surface in which a primer containing a platinum type compound and a solvent but not containing an alkoxy silane is applied and dried on the surface of a metal or an alloy containing at least one metal selected from a group of gold, silver and platinum group, and the thermally-conductive silicone composition is subsequently adhered to the coated surface.

2. The method described in claim 1 wherein the thermally-conductive silicone composition contains
(A) an organo polysiloxane containing at least two alkenyl groups in a molecule and having a viscosity at 25° C. of from 10 mm²/s to 100,000 mm²/s and
(B) an organohydrogen polysiloxane shown by the General Formula (1) below. 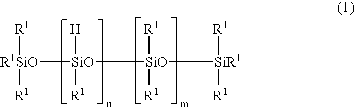
[in the formula R¹ represents an alkyl group with one to six carbon atoms and n and m indicate positive numbers that satisfy 0.01≦n/(n+m)≦0.3.]

3. A primer for adhering a thermally-conductive silicone composition containing at least one material selected from a group of platinum free particles, platinum supported particles, chloroplatinic acid, platinum complexes and platinum coordinate compounds yet not containing an alkoxy silane that is used to adhere the thermally-conductive silicone composition on the surface of a metal or an alloy containing at least one metal selected from a group of gold, silver and platinum group.

4. A method for manufacturing a bonded complex of a thermally-conductive silicone composition in which a primer containing a platinum type compound and a solvent but not containing an alkoxy silane is applied and dried on the surface of a metal or an alloy containing at least one metal selected from a group that includes gold, silver and platinum group, and the thermally-conductive silicone composition is subsequently adhered to the coated surface.
